(19) United States
(12) Patent Application Publication
(10) Pub. No.: US 2011/0064018 A1
(43) Pub. Date: Mar. 17, 2011

(54) Apparatus and Method for Input/Output Mapping of Spatial Resources of a Relay Node in a Communication System

(76) Inventor: Ari Hottinen, Espoo (FI)

(21) Appl. No.: 12/558,856

(22) Filed: Sep. 14, 2009

(51) Int. Cl. H04B 7/14; H04W 72/04

(52) U.S. Cl. 370/315; 370/329

(57) ABSTRACT

An apparatus and method for input/output mapping of spatial resources of a relay node in a communication system. In one embodiment, the apparatus includes a channel manager configured to identify a plurality of channels bearing signal streams from a source node to a plurality of destination nodes via a relay node having a plurality of antennas. The apparatus also includes a channel allocator configured to employ input/output mapping for a plurality of spatial resources of the relay node as a function of channel characteristics of the plurality of channels for the signal streams.

### TECHNICAL FIELD

The present invention is directed, in general, to communication systems and, in particular, to an apparatus and method for input/output mapping of a plurality of spatial resources of a relay node in a communication system.

### BACKGROUND

Long Term Evolution (“LTE”) of the Third Generation Partnership Project (“3GPP”), also referred to as 3GPP LTE, refers to research and development involving the 3GPP Release 8 and beyond, which is the name generally used to describe an ongoing effort across the industry aimed at identifying technologies and capabilities that can improve systems such as the universal mobile telecommunication system (“UMTS”). The goals of this broadly based project include improving communication efficiency, lowering costs, improving services, making use of new spectrum opportunities, and achieving better integration with other open standards. The 3GPP LTE project is not itself a standard-generating effort, but will result in new recommendations for standards for the UMTS. Further developments in these areas are also referred to as Long Term Evolution-Advanced (“LTE-A”).

The evolved UMTS terrestrial radio access network (“E-UTRAN”) in 3GPP includes base stations providing user plane (including packet data convergence protocol/radio link control/medium access control/physical (“PDCP/RLC/MAC/PHY”) sublayers) and control plane (including radio resource control (“RRC”) sublayer) protocol terminations towards wireless communication devices such as cellular telephones. A wireless communication device or terminal is generally known as user equipment (“UE”) or a mobile station (“MS”). A base station is an entity of a communication network often referred to as a Node B or an NB. Particularly in the E-UTRAN, an “evolved” base station is referred to as an eNodeB or an eNB. For details about the overall architecture of the E-UTRAN, see 3GPP Technical Specification (“TS”) 36.300, v8.5.0 (2008-05), which is incorporated herein by reference. The terms base station, NB, eNB, and cell refer generally to equipment providing the wireless-network interface in a cellular telephone system, and will be used interchangeably herein, and include cellular telephone systems other than those designed under 3GPP standards.

Orthogonal frequency division multiplexing (“OFDM”) is a multi-carrier data transmission technique that is advantageously used in radio frequency based transmitter-receiver systems such as 3GPP E-UTRAN/LTE/3.9G, IEEE 802.16d/e (Worldwide Interoperability for Microwave Access (“WiMAX”)), IEEE 802.11a/WiFi, fixed wireless access (“FWA”), HiperLAN2, digital audio broadcast, (“DAB”), digital video broadcast (“DVB”), and others including wired digital subscriber lines (“DSLs”). The OFDM systems typically divide available frequency spectrum into a plurality of carriers that are transmitted in a sequence of time slots. Each of the plurality of carriers has a narrow bandwidth and is modulated with a low-rate signal stream. The carriers are closely spaced and orthogonal separation of the carriers controls inter-carrier interference (“ICI”).

When generating an OFDM signal, each carrier is assigned a signal stream that is converted to samples from a constellation of admissible sample values based on a modulation scheme such as quadrature amplitude modulation (“QAM,”) including binary phase shift keying (“BPSK”), quadrature phase shift keying (“QPSK”), and higher-order variants (16QAM, 64QAM, etc), and the like. Once phases and amplitudes are determined for the particular samples, they are converted to time-domain signals for transmission. A sequence of samples, such as a 128-sample sequence, is collectively assembled into a “symbol.” Typically, OFDM systems use an inverse discrete Fourier transform (“iDFT”) such as an inverse fast Fourier transform (“iFFT”) to perform conversion of the symbols to a sequence of time-domain sample amplitudes that are employed to form a time domain transmitted waveform. The iFFT is an efficient process to map data onto orthogonal subcarriers. The time domain waveform is then up-converted to the radio frequency (“RF”) of the appropriate carrier and transmitted. A particular issue for system operation including OFDM is calibration of frequency of a local oscillator in the user equipment and absolute time at the user equipment so that an OFDM signal can be accurately detected and demodulated.

As wireless communication systems such as cellular telephone, satellite, and microwave communication systems become widely deployed and continue to attract a growing number of users, there is a pressing need to accommodate a large and variable number of communication devices transmitting a growing range of communication applications with fixed communication resources. The 3GPP is currently studying various potential enhancements to the 3GPP LTE Release 8 to specify a new system called LTE-Advanced which is supposed to fulfill the International Mobile Telecommunications-Advanced (“IMT-Advanced”) requirements set by the International Telecommunications Union-Radiocommunication Sector (“ITU-R”). Topics within the ongoing study item include bandwidth extensions beyond 20 megahertz (“MHz”), communication link relays, cooperative multiple input/multiple output (“MIMO”), uplink multiple access schemes, and MIMO enhancements. Closed loop spatial multiplexing and spatial layers address issues related to controlling gain and phasing of a plurality of transmit and receive antennas to, for instance, improve a signal-to-interference ratio, improve a user throughput measurement, or to null or otherwise attenuate an interfering signal. Interference avoidance, nulling or mitigation are also pertinent to future cognitive wireless communication systems or ad-hoc wireless communication systems (such as IEEE Standard 802.11 and 802.16, which are incorporated herein by reference), wherein quasi-orthogonal channels (e.g., beams, timeslots, frequency slots) are continuously sought from the wireless medium.

Optimization of antenna weighting, particularly at an antenna of a relay node, is a known technique to improve performance of a communication channel or channel for the case wherein one user equipment transmits at a given time or in a given channel through the relay node. Decoupling multiple source signals at a destination node by selection of relay node antenna weighting is also a known technique. However, when multiple signal streams destined for multiple destination nodes arrive simultaneously at a multi-antenna relay node, limited communication performance improvement can be obtained using known techniques. Thus, an improved strategy, not only for selection of antenna weighting, but also for the use of antennas more generally (such as antenna selection) at a relay node constructed with a plurality of antennas, particularly in an environment wherein a plurality of signals simultaneously arrive at and are simultaneously forwarded by the relay node, would provide an advantageous level of communication system performance.

In view of the growing deployment and sensitivity of users to communication performance and inter-channel interference of simultaneous signal streams in a communication system such as a cellular communication system or a local area network, further improvements are necessary for handling signal streams simultaneously by a relay node. Therefore, what is needed in the art is a system and method that avoid the associated deficiencies of conventional communication systems in accordance with forwarding signal streams at a relay node constructed with a plurality of antennas.

### SUMMARY OF THE INVENTION

These and other problems are generally solved or circumvented, and technical advantages are generally achieved, by embodiments of the present invention, which include an apparatus and method for input/output mapping of a plurality of spatial resources of a relay node in a communication system. In one embodiment, the apparatus (e.g., a processor) includes a channel manager configured to identify a plurality of channels bearing signal streams from a source node to a destination node via a relay node. The apparatus also includes a channel allocator configured to employ input/output mapping for a plurality of spatial resources of the relay node as a function of channel characteristics of the plurality of channels for the signal streams.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an environment for application of the principles of the present invention;

FIGS. 3 and 4 illustrate system level diagrams of embodiments of communication systems including a wireless communication systems that provide an environment for application of the principles of the present invention;

FIG. 5 illustrates a block diagram of a wireless communication system including a source node, a relay node, and a destination node that provides an environment for application of the principles of the present invention;

FIG. 6 illustrates a system level diagram of an embodiment of a communication element of a communication system for application of the principles of the present invention;

FIG. 7 illustrates a flow diagram demonstrating an exemplary method for selecting input/output mapping for a plurality of spatial resources of a relay node in a communication system according to the principles of the present invention;

FIG. 8A illustrates a graphical representation demonstrating relative mutual information at a destination node in accordance with an embodiment of a relay node of the present invention; and

FIG. 8B illustrates a graphical representation demonstrating a ratio of mutual information at a destination node in accordance with an embodiment of a relay node of the present invention compared to a conventional relay node.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of an apparatus, system and method for input/output mapping of spatial resources at a relay node constructed with a plurality of antennas, including antenna weighting coefficients, to obtain improved channel performance in a communication system. Although apparatus, system and methods described herein are described with reference to a 3GPP LTE communication system, the apparatus, system and methods may be applied with respect to other communication systems as well. For example, the apparatus, system and method can be applied in ad-hoc communication systems, wireless local area networks and personal area networks, wireless broadcast communication systems (such as digital video broadcast communication systems and its variants) or emerging wireless communication systems such as cognitive radio communication systems.

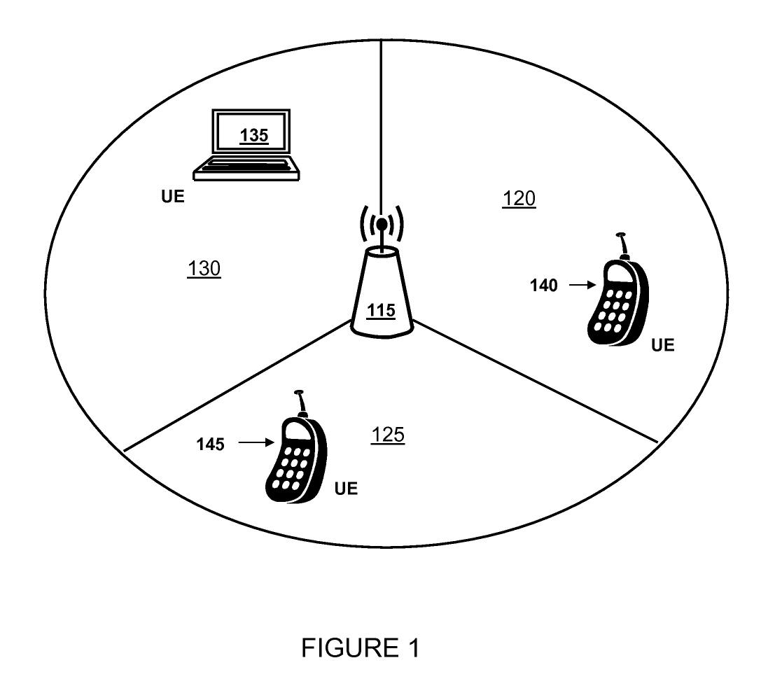

Turning now to FIG. 1, illustrated is a system level diagram of an embodiment of a communication system including a base station 115 and wireless communication devices (e.g., user equipment) 135, 140, 145 that provides an environment for application of the principles of the present invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. Although FIG. 1 illustrates one wireless communication device (e.g., wireless communication device 140) in each sector (e.g., the first sector 120), a sector (e.g., the first sector 120) may generally contain a plurality of wireless communication devices. In an alternative embodiment, a base station 115 may be formed with only one sector (e.g., the first sector 120), and multiple base stations may be constructed to transmit according to collaborative/cooperative MIMO (“C-MIMO”) operation, etc. The sectors (e.g., the first sector 120) are formed by focusing and phasing radiated signals from the base station antennas, and separate antennas may be employed per sector (e.g., the first sector 120). The plurality of sectors 120, 125, 130 increases the number of subscriber stations (e.g., the wireless communication devices 135, 140, 145) that can simultaneously communicate with the base station 115 without the need to increase the utilized bandwidth by reduction of interference that results from focusing and phasing base station antennas. For a better understanding of MIMO coordination in sectorized communication systems, see a paper entitled “Increasing Downlink Cellular Throughput with Limited Network MIMO Coordination,” by Huang, et al. (“Huang”), published in IEEE Transactions on Wireless Communications, Volume 8, No. 6, June 2009, which is incorporated herein by reference.

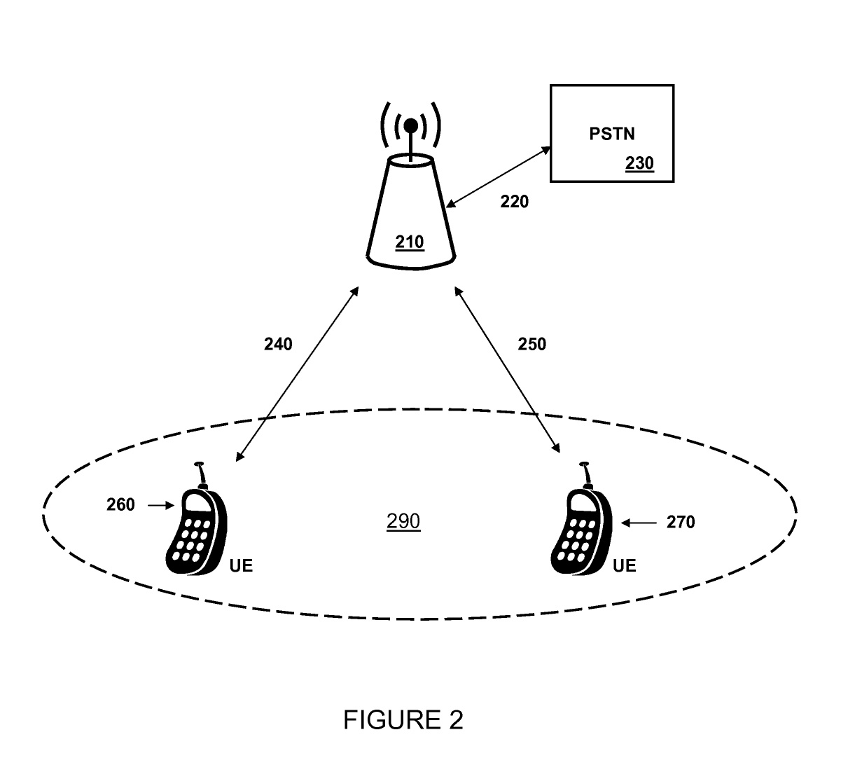

Turning now to FIG. 2, illustrated is a system level diagram of an embodiment of a communication system including wireless communication devices that provides an environment for application of the principles of the present invention. The communication system includes a base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to wireless communication devices 260, 270, respectively, that lie within its cellular area 290.

In operation of the communication system illustrated in FIG. 2, the base station 210 communicates with each wireless communication device 260, 270 through control and data communication resources allocated by the base station 210 over the communication paths 240, 250, respectively. The control and data communication resources may include frequency and time-slot communication resources in frequency division duplex (“FDD”) and/or time division duplex (“TDD”) communication modes.

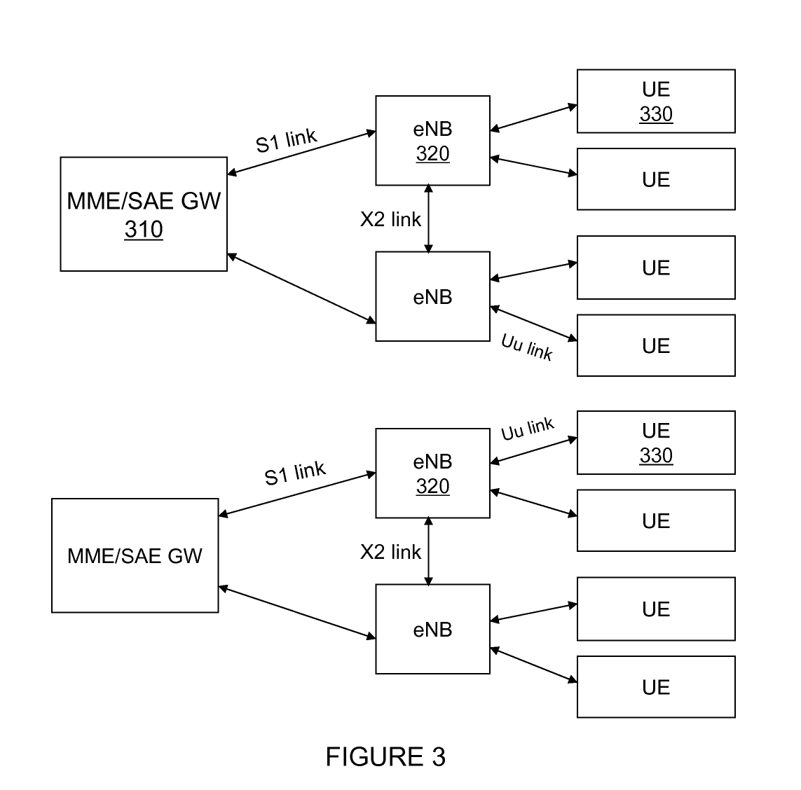

Turning now to FIG. 3, illustrated is a system level diagram of an embodiment of a communication system including a wireless communication system that provides an environment for the application of the principles of the present invention. The wireless communication system may be configured to provide evolved UMTS terrestrial radio access network (“E-UTRAN”) universal mobile telecommunications services. A mobile management entity/system architecture evolution gateway (“MME/SAE GW,” one of which is designated 310) provides control functionality for an E-UTRAN node B (designated “eNB,” an “evolved node B,” also referred to as a “base station,” one of which is designated 320) via an S1 communication link (ones of which are designated “S1 link”). The base stations 320 communicate via X2 communication links (designated “X2 link”). The various communication links are typically fiber, microwave, or other high-frequency metallic communication paths such as coaxial links, or combinations thereof.

The base stations 320 communicate with user equipment (“UE,” ones of which are designated 330), which is typically a mobile transceiver carried by a user. Thus, communication links (designated “Uu” communication links, ones of which are designated “Uu link”) coupling the base stations 320 to the user equipment 330 are air links employing a wireless communication signal such as, for example, an orthogonal frequency division multiplex (“OFDM”) signal.

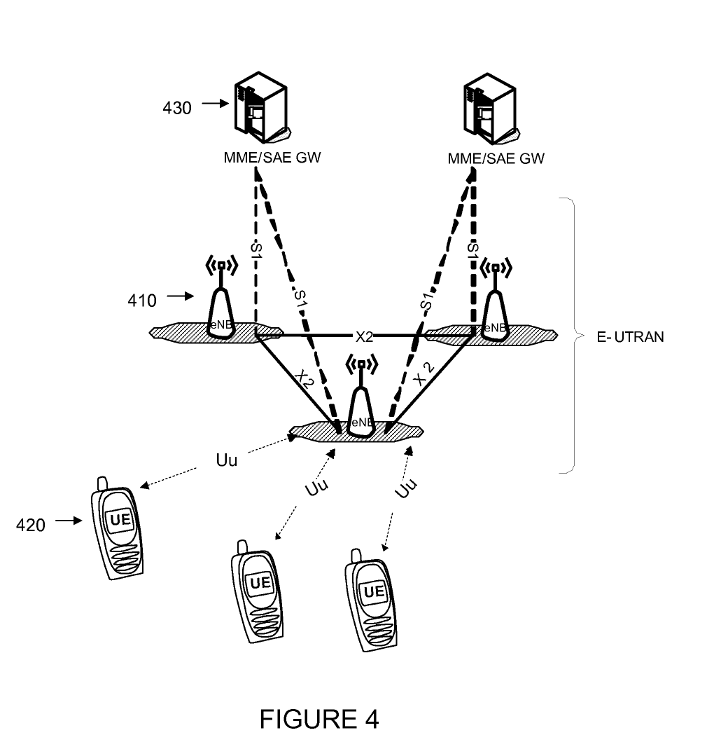

Turning now to FIG. 4, illustrated is a system level diagram of an embodiment of a communication system including a wireless communication system that provides an environment for the application of the principles of the present invention. The wireless communication system provides an E-UTRAN architecture including base stations (one of which is designated 410) providing E-UTRAN user plane (packet data convergence protocol/radio link control/media access control/physical) and control plane (radio resource control) protocol terminations towards user equipment (one of which is designated 420). The base stations 410 are interconnected with X2 interfaces or communication links (designated “X2”). The base stations 410 are also connected by S1 interfaces or communication links (designated “S1”) to an evolved packet core (“EPC”) including a mobile management entity/system architecture evolution gateway (“MME/SAE GW,” one of which is designated 430). The S1 interface supports a multiple entity relationship between the mobile management entity/system architecture evolution gateway 430 and the base stations 410. For applications supporting inter-public land mobile handover, inter-eNB active mode mobility is supported by the mobile management entity/system architecture evolution gateway 430 relocation via the S1 interface.

The base stations 410 may host functions such as radio resource management. For instance, the base stations 410 may perform functions such as internet protocol (“IP”) header compression and encryption of user signal streams, ciphering of user signal streams, radio bearer control, radio admission control, connection mobility control, dynamic allocation of resources to user equipment in both the uplink and the downlink, selection of a mobility management entity at the user equipment attachment, routing of user plane data towards the user plane entity, scheduling and transmission of paging messages (originated from the mobility management entity), scheduling and transmission of broadcast information (originated from the mobility management entity or operations and maintenance), and measurement and reporting configuration for mobility and scheduling. The mobile management entity/system architecture evolution gateway 430 may host functions such as distribution of paging messages to the base stations 410, security control, termination of U-plane packets for paging reasons, switching of U-plane for support of the user equipment mobility, idle state mobility control, and system architecture evolution bearer control. The user equipment 420 receives an allocation of a group of information blocks from the base stations 410.

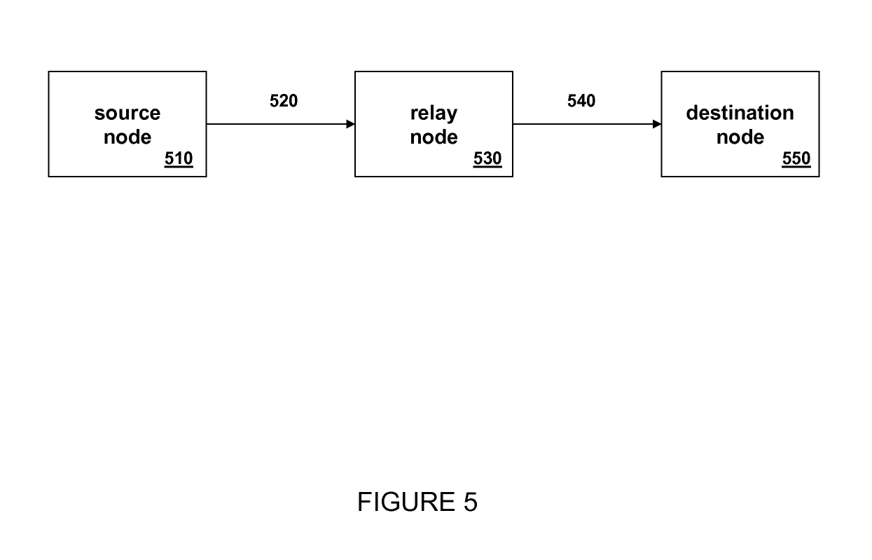

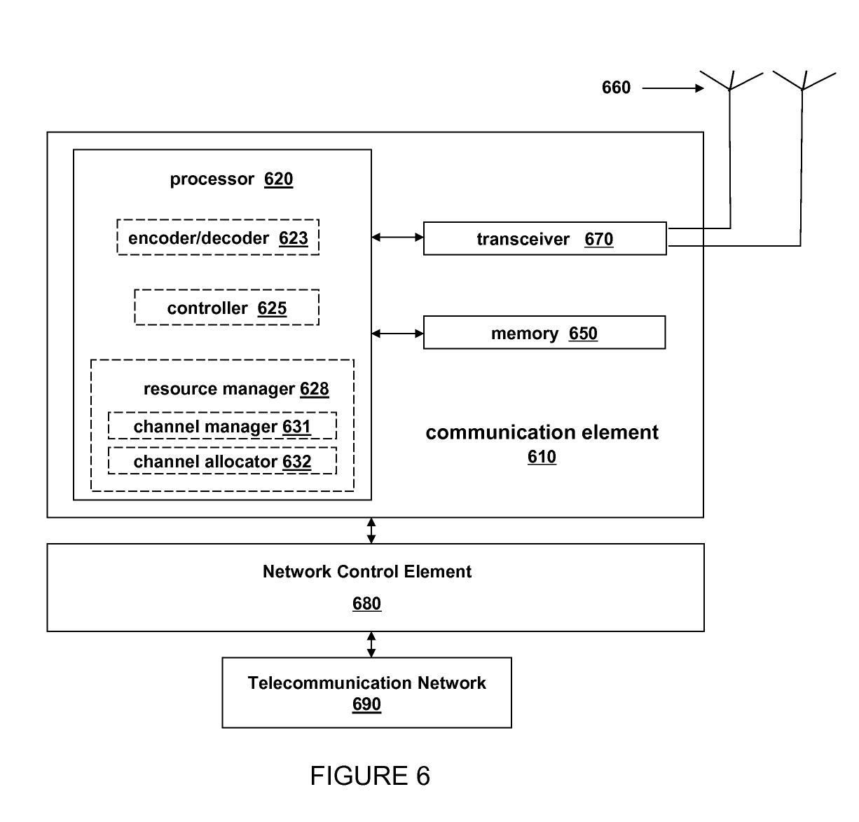

Turning now to FIG. 5, illustrated is a block diagram of a wireless communication system including a source node 510, a relay node 530, and a destination node 550 that provides an environment for application of the principles of the present invention. The source node 510 communicates with the relay node 530 in a downlink 520, and the relay node 530 communicates in a downlink 540 with the destination node 550. A plurality of signal streams are received and transmitted at the relay node 530 simultaneously or at different times. The relay node 530 may be constructed to perform an amplify-and-forward relaying function or by a detection and forwarding relay function. The relay node 530 may be formed and include elements as described hereinbelow with reference to FIG. 6. The relay node 530 may be constructed with a plurality of antennas.

Turning now to FIG. 6, illustrated is a system level diagram of an embodiment of a communication element 610 of a communication system for application of the principles of the present invention. The communication element or device 610 may represent, without limitation, a base station, user equipment (e.g., a subscriber station, a terminal, a mobile station, a wireless communication device), a network control element, a communication node such as a relay node, or the like. The communication element 610 includes, at least, a processor 620, memory 650 that stores programs and data of a temporary or more permanent nature, a plurality of antennas (one of which is designated 660), and a radio frequency transceiver 670 coupled to the antennas 660 and the processor 620 for bidirectional wireless communication. The communication element 610 may provide point-to-point and/or point-to-multipoint communication services.

The communication element 610, such as a base station in a cellular network, may be coupled to a communication network element, such as a network control element 680 of a public switched telecommunication network (“PSTN”) 690. The network control element 680 may, in turn, be formed with a processor, memory, and other electronic elements (not shown). The network control element 680 generally provides access to a telecommunication network such as a PSTN 690. Access may be provided using fiber optic, coaxial, twisted pair, microwave communication, or similar link coupled to an appropriate link-terminating element. A communication element 610 formed as user equipment is generally a self-contained device intended to be carried by an end user.

The processor 620 in the communication element 610, which may be implemented with one or a plurality of processing devices, performs functions associated with its operation including, without limitation, encoding and decoding (encoder/decoder 623) of individual bits forming a communication message, formatting of information, and overall control (controller 625) of the communication element, including processes related to management of resources via a resource manager 628. Exemplary functions related to management of resources include, without limitation, hardware installation, traffic management, performance data analysis, tracking of end users and equipment, configuration management, end user administration, management of user equipment, management of tariffs, subscriptions, and billing, and the like. For instance, in accordance with the memory 650, the resource manager 628 is configured to allocate time and frequency communication resources for transmission of data to/from the communication element 610 during, for instance, multi-user MIMO (also referred to as “MU-MIMO”) modes of operation and format messages including the communication resources therefore.

In accordance with a relay node, the resource manager 628 may include a channel manager 631 configured to identify a plurality of channels bearing signal streams from a source node to a plurality of destination nodes (via, for instance, zero-forcing beamforming) and obtain channel characteristics for the plurality of channels. The resource manager 628 may also include a channel allocator 632 configured to employ input/output mapping for a plurality of spatial resources of the relay node as a function of the channel characteristics of the plurality of channels for the signal streams. For instance, the channel allocator 632 may select antenna or beam input/output mapping (including antenna weighting or beamforming coefficients) for the antennas 660 of the relay node as a function of the channel characteristics for the signal streams over the plurality of channels from the source node to the plurality of destination nodes. Thus, the resource manager 628 may control transmissions from source node(s) to destination node(s) through the relay node that is constructed with a plurality of antennas or beams 660. The resource manager 628 may determine transmission weights such as an antenna weighting matrix for the antennas 660 at a relay node so that signal reception is improved at one or more of the destination nodes, as well as the antenna or beam input/output mapping. In accordance with the foregoing, the relay node may receive the input/output mapping for the plurality of spatial resources from one of the destination nodes. The input/output mapping for the plurality of spatial resources may be selected to reduce interference between the plurality of channels for the signal streams.

The execution of all or portions of particular functions or processes related to management of resources may be performed in equipment separate from and/or coupled to the communication element 610, with the results of such functions or processes communicated for execution to the communication element 610. The processor 620 of the communication element 610 may be of any type suitable to the local application environment, and may include one or more of general-purpose computers, special purpose computers, microprocessors, digital signal processors (“DSPs”), and processors based on a multi-core processor architecture, as non-limiting examples.

The transceiver 670 of the communication element 610 modulates information onto a carrier waveform for transmission by the communication element 610 via the antennas 660 to another communication element such as a destination node. The transceiver 670 demodulates information received via the antenna 660 for further processing by other communication elements. The transceiver 670 is capable of supporting duplex operation for the communication element 610.

The memory 650 of the communication element 610, as introduced above, may be of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 650 may include program instructions that, when executed by an associated processor, enable the communication element 610 to perform tasks as described herein. Of course, the memory 650 may form a data buffer for data transmitted to and from the communication element 610. Exemplary embodiments of the system, subsystems, and modules as described herein may be implemented, at least in part, by computer software executable by processors of, for instance, the user equipment and the base station, or by hardware, or by combinations thereof. As will become more apparent, systems, subsystems and modules may be embodied in the communication element 610 as illustrated and described herein.

As described above, a communication system may be formed with at least one source node that transmit(s) signal steams over a plurality of channels, a relay node constructed with a plurality of antennas, and at least one destination node that receive(s) the plurality of signal streams. The plurality of signal streams may be transmitted by a combination of a plurality of source nodes that each transmits a single signal stream and a source node that transmits a plurality of signal streams. The system should rely on spatial diversity to obtain a significant performance gain at the destination node(s). In particular, the problem is related to the use of individual link (or effective link) coefficients (or channel characteristics such as channel state information, “CSI,” or channel quality information, “CQI”) to control transmissions from either the source node(s) or the relays node(s). Also, the problem is related to determining transmission weights or a transmission matrix such that signal reception is improved at the destination node(s).

Many references have addressed optimization of spatial resources such as antenna weighting at relay nodes or elsewhere. For example, a paper entitled “Spectral Efficient Protocols for Half-duplex Fading Relay Channels,” by B. Rankov and A. Wittneben (hereinafter “Rankov”), published in the IEEE Journal on Selected Areas in Communications, February 2007, and a paper entitled “Recent Advances in Amplify-and-Forward Two-Hop Relaying,” by S. Berger, T. Unger, M. Kuhn, A. Klein, and A. Wittneben (hereinafter “Berger”), published in IEEE Communications Magazine, January 2009, which are incorporated herein by reference, discuss multi-user zero-forcing relaying, wherein each relay node has one receive antenna and one weighting coefficient per receive antenna. Zero-forcing relates to selecting antenna weight vectors to avoid interference between users. For example, for a particular user equipment, the antenna weight vector would be selected so that the product of the antenna weight vector and a vector representing the user equipment's channel characteristics would be zero (i.e., the antenna weight vector and the vector representing the user equipment's channel characteristics would be orthogonalized). The orthogonalization only requires knowledge of the user equipment's channel characteristics. Rankov and Berger show that with a sufficient number of relay nodes and appropriately selected antenna weighting coefficients, multiple source signal streams can be fully decoupled for a destination node. A MIMO-relay channel is thereby orthogonalized by relay nodes performing channel-aware virtual scattering.

Additionally, a paper entitled “Distributed Subchannel Assignment in a Multiuser MIMO Relay,” by T. Heikkinen and A. Hottinen (hereinafter “Heikkinen”), published in the Proceedings of Gamecomm '07, Nantes, France, October 2007, which is incorporated herein by reference, describes a multi-user MIMO relay with input/output beam selection at a relay node. In this paper, only one user equipment transmits at a given time or in a given channel. Heikkinen describes the use of orthogonal channels (time-frequency slots that are different for different signal streams) to decouple multiple signal streams so that spatial channel information (or optimization of beams) is not needed to remove or reduce interference between the signal streams. By decoupling interference as introduced herein, only one time-frequency slot is needed to transmit N signal streams (with N input and N output antennas/beams). The process introduced herein is different from that described by Heikkinen in that a plurality of possible input/output mapping of spatial resources such as input/output antenna/beam mappings are examined, each of which can be associated with (possibly) different antenna weighting coefficients to further increase the set of possible channels. Heikkinen does not detail how input/output mappings are implemented, as the point of the Heikkinen paper is in optimization aspects. Heikkinen also does not discuss channel-aware beam/stream weighting and its use in finding optimal indexing. Channel-aware beam/stream weighting is represented in equations introduced and described hereinbelow by the effect of an antenna weighting coefficient matrix Λ₂ dependent on a permutation matrix π. Also, U.S. Patent Application Publication No. 2007/0098102, entitled “Apparatus, Method and the Computer Program Product Providing Sub-Channel Assignment for Relay Node,” by Ari Hottinen, published May 3, 2007, which is incorporated herein by reference, is related to optimization of transmission of a signal stream from a source node to a destination node through a relay node.

As introduced herein, different input/output mapping of spatial resources such as antenna input/output mapping (also referred to as “indexing”) alternatives provide a different effective MIMO channel, wherein differences between different indexing can be quite large from a point of view of channel performance. Antenna mapping or indexing refers to how a plurality of signals arriving at the receive antennas or beams of the relay node are assigned to a plurality of transmit antennas or beams at the relay node. Different assignments may or may not transmit different effectively signal streams. Any given receive antenna may contain a superposition of more than one signal stream (as is apparent with subsequent signal model). Changing antenna indexing can be implemented in a relay node communication system, possibly both at the relay input antennas and the relay output antennas (beams). By providing or modifying antenna indexing, one can enhance channel performance with weighting of beams or signal streams by using channel information (i.e., selecting input/output mapping for a plurality of antennas as a function of the channel characteristics for the signal streams over a plurality of channels).

A paper entitled “Capacity of MIMO Systems with Antenna Selection,” by Andreas F. Molisch, Moe Z. Win, and Jack H. Winters (hereinafter “Molisch”), published in IEEE International Conference on Communications Volume 2, pp. 570-574, Jun. 11, 2001, which is incorporated herein by reference, discusses selection of a subset of antennas to reduce the number of radio frequency (“RF”) chains in a single link and without an intervening relay. Molisch does not discuss a permutation selection process for all antennas with different indexing as introduced herein. Thus, Molisch suggests a simplified radio frequency implementation and does not improve the overall performance when compared to a MIMO system wherein multiple antennas are used. In contrast, the resource allocation introduced herein is applied to a different network entity (e.g., a relay node) and the method of finding appropriate input/output mapping of spatial resources such as input/output mapping of radio frequency chains, and/or antenna or beam selection improves the end-to-end performance of the channel regardless of what is done at the transmitter and receiver alone (i.e., even if known antenna selection methods are applied at the source node or a destination node). As introduced herein, the antennas of the relay node can be used and their indexing or input/output mapping is modified, not just a number of active antennas, wherein the channels between the source node(s) and destination nodes(s) via the relay node affect the mapping.

In contrast to the arrangement described by Heikkinen, the case is described herein wherein multiple signal streams (for example, S signal sources, or one signal source with S signal streams, or a combination of S such signal sources) arrive at a relay node with a plurality of antennas R. The relay node has multiple transmit antennas, both at an input and output thereof. Received signals at each input (or output) antenna may be subjected to complex weight multiplication, such as described by Rankov and Berger.

A controllable input/output mapping for a plurality of spatial resources such as MIMO-relay antennas (beams) is introduced to improve communication performance at respective destination nodes. If only one signal stream arrives at a relay node, then Heikkinen describes a process to assign resources such as antenna weighting coefficients at the relay node so that network performance is enhanced. However, the problem is different when multiple signal streams (e.g., multiple simultaneous signal streams) arrive at the relay node on the same time-frequency slot, for example, from multiple source nodes (e.g., base stations). Improved selection of spatial resources such as input and output beams, antennas, radio frequency chains and channels is introduced to improve system performance. For example, in a cellular system (e.g., in an LTE cellular system) such a relay node could be located in the coverage area of two (or more) base stations, and the relay node would determine a better way to retransmit signal streams to destination nodes such as base stations (in uplinks) or to the user equipment (in downlinks) so that communication performance is improved. Without restriction, the source-destination node pairs are assumed fixed, and there are at least two concurrently operating active source-destination node pairs.

Consider, as an example, a downlink scenario, wherein two user equipment are receiving information from a relay node that receives information from two different base stations (or access points, etc.). Signal stream 1 (intended for user equipment 1) arrives at the relay node from base station 1, and signal stream 2 (intended for user equipment 2) arrives simultaneously at the relay node from base station 2. Assume that the relay node has four antennas for reception and four antennas for transmission. As described by Rankov and by Berger, the signal streams can be fully orthogonalized, for example, by using zero-forcing beamforming at the relay node, so that neither node sees any interference from that intended for the other node by the use of four complex-valued antenna weighting coefficients at the relay node.

As introduced herein, the antenna weighting coefficients for each, or for at least two, input/output mapping are computed, and a related performance measure (e.g., a channel characteristic such as a channel throughput or a channel capacity estimate from a pilot signal in a signal stream from the source to the destination node) for each such mapping is produced. The relay node selects the input/output mapping that produces a desired (e.g., optimal) performance as indicated by the related performance measure. A MIMO relay network considered herein includes S source nodes (or S signal streams), an R-antenna relay node, and D destination nodes.

Channel performance estimates can be either computed at, for instance, the relay node or at the destination node depending on signaling capabilities or solutions. Orthogonalized antenna weighting coefficients depend on the relay input and output channels, which are known at the location where the orthogonalized antenna weighting computation takes place. As an example, Rankov describes a process for computing orthogonalized antenna weighting coefficients for a particular communication path. For a MIMO relay node, input/output mapping requires little or no additional signaling, since input/output mapping is typically an internal operation at a relay node. To aid the signal processing tasks, such as channel identification or estimation, of a destination node, it may be beneficial to signal to the destination node information related to any changes in the antenna indexing at relay node. Determining the proper mapping requires a relatively straightforward additional computation that includes computing a performance measure for each mapping and selecting a mapping with an extremal value for the performance measure, such as a maximal value. Thus, the added computation to achieve enhanced performance is reasonable in view of the computation described by Rankov and by Berger.

In a relay node in a wireless communication system, a source node s, where s=1, . . . S, transmits a signal stream x(s). The S signal streams x(s), which may originate at a plurality of source nodes S or may represent S signal streams at one source node, are collected in a vector x, and they arrive at a relay node through an (S×R) MIMO channel described by an input channel matrix F with total transmit power P.

Each relay node antenna/beam multiplies its respective received signal stream with an antenna/beam-specific complex weighting coefficient w_{γ} , γ=1, . . . , R. These complex weighting coefficients w_{γ} are collected in a diagonal weighting coefficient matrix

Λ₂=diag(w₁, . . . ,w_{R}). (1)

The (D×R) MIMO channel (representing combinations of the D destination nodes and the R antennas at the relay node) from the relay node to each destination node is described by the output channel matrix H. In a two-hop amplify-and-forward network, the destination node receives the signal represented by equation (2):

y=HΛ₂Fx+HΛ₂n_{γ}+n_{d}, (2)

wherein the elements of complex Gaussian vector n_{γ} represent noise with variance σ²_{γ} received at each relay node receive antenna (which is amplified and forwarded), and elements of n_{d} represent complex Gaussian noise with variance σ²_{d} received at each destination node antenna.

The mutual information α with independent and identically distributed Gaussian noise sources (in terms of bits-per-channel use) for the signal model represented by equation (2) is given by equation (3):

$$α = ( \frac{1}{2} ) {log}_{2} det ( I + PH {Λ}_{2} {FF}^{CT} {Λ}_{2}^{CT} {H}^{CT} {R}_{nn}^{- 1} ) , \qquad ( 3 )$$

wherein the noise correlation matrix Rₙₘ is given by the equation (4),

Rₙₙ=σ²_{d}I+σ²_{γ}HΛ₂Λ₂^{CT}H^{CT}. (4)

The exponent symbol “CT” represents complex conjugation and transposition of the indicated matrix. The factor ½ in the model represented by equation (3) is due to time and/or frequency separation of receive and transmit channels in a two-hop relay scenario.

As introduced herein, each relay node antenna/beam multiplies its respective received signal stream with an antenna/beam-specific complex weighting coefficient w_{γ} wherein the coefficient w_{γ} is selected for a given input/output mapping. A permutation (or switching) matrix π is determined in the relay node to modify the effective channels. This modifies the performance measure for mutual information a represented above by equation (3) to:

$$α = ( \frac{1}{2} ) {log}_{2} det ( I + PH {Λ}_{2} Π {FF}^{CT} {ΠΛ}_{2}^{CT} {H}^{CT} {R}_{nn}^{- 1} ) , \qquad ( 5 )$$

wherein the noise correlation matrix Rₙₘ is given by:

Rₙₘ=σ²_{d}I+σ²_{γ}HΛ₂Λ₂^{CT}H^{CT}. (6)

The factor ½ in the model represented by equation (5) is again due to separation of receive and transmit channels in two-hop relay scenario.

The weighting coefficients in the matrix Λ₂=Λ₂(π) now depends on the selected permutation matrix π, wherein each antenna weighting coefficient designates one antenna input/output mapping. There are R! (where exclamation mark designates factorial, i.e. R!=R*(R−1)* . . . *1) permutation matrices π. The additional computational task is to compute these antenna weighting coefficients for each (or for at least two) of the permutation matrices π, using, for example, zero-forcing beamforming methods described by Rankov and by Berger. The performance measure for mutual information a now represented by α(π) is represented by equation (7) to reflect the dependence of the weighting coefficient matrix Λ₂ on the permutation matrix π:

$$α ( Π ) = ( \frac{1}{2} ) {log}_{2} det ( I + PH {Λ}_{2} ( Π ) Π {FF}^{CT} {ΠΛ}_{2}^{CT} ( Π ) {H}^{CT} {R}_{nn}^{- 1} ) , \qquad ( 7 )$$

wherein the noise correlation matrix Rₙₙ is again given by equation (6) above.

The matrix Λ(π) in equation (7) above generally depends on both the relay node-to-destination node channel(s) and the source node-to-relay node channel(s), which can be estimated by known means using pilot signals transmitted to the relay node in a reverse duplex direction, or via feedback channels providing estimates of channel characteristics fed back to the relay node via signaling fields. A straightforward way of solving indexing would be to determine indexing based on the input channel matrix F and the output channel matrix H alone, then computing the matrix Λ₂ for a given input channel matrix F and output channel matrix H, which may be performed jointly.

Other aspects of the channel(s) or link(s) can be accounted for when solving the indexing. For example, if a data rate or quality of service requirement of one signal stream is higher than that of another signal stream, this information may be signaled to the relay nodes, the selection of input/output mapping may be different or be affected to reflect the data-rate or quality of service difference. As an example, the relay node may decide to use indexing that favors one signal stream over the other. In another other case, the relay node may attempt to equalize the data rates or quality of service of the signal streams by selecting appropriate indexing. The relay node may select indexing that provides the greatest improvement for the weakest signal stream. Thus, indexing at the relay node may generally depend on quality of service parameters of different signal streams as well as channel characteristics.

The equation (7) above relates to computing the total capacity of the signal streams. This criterion may be modified if another criterion is selected. For example, the modified criteria may lead to computing the per-signal stream signal-to-noise (“SNR”) ratios (or capacities or channel quality indicators) and selecting the permutation that augments a higher value associated therewith, or a more optimal value in line with selected quality indicator. The used or suggested criterion can be signaled to the relay node.

In addition to channel-aware weighting, the relay node can use pseudo-random antenna weighting coefficients that do not strictly depend on channel. In this case, the indexing can be computed for each pseudo-random weighting, but the proper indexing varies even if the input and output channel matrices F, H are constant. The proper indexing can be signaled from the destination node or source node to the relay node. This alternative implementation leads to somewhat reduced capacity, but is easier to implement because the relay node does not need to rely on the channel characteristics. The relay node only needs to listen to “indexing messages” from external nodes (source nodes or destination nodes).

For implementation of an embodiment, the relay node includes the capability to change the input/output mapping of spatial resources. This can be implemented with a simple antenna switch (e.g., with fixed (analog) beamforming matrixes at the relay node), or with digital beamforming (e.g., for at most R! different selectable beams). Similar technology is already available for transmit antenna or receive antenna selection for transmit diversity or receive diversity purposes. The relay node input channel matrix F need not necessarily use the same technology as the relay node output channel matrix H. For example, one of them could be a wideband local area network (“WLAN”) such as a WiFi (IEEE Standard 802.11) local area network, while the other could be an LTE cellular communication system. In other words, the relay node may employ a first type of channel with respect to signal streams from the source node(s) and a second type of channel with signal streams to the destination node(s).

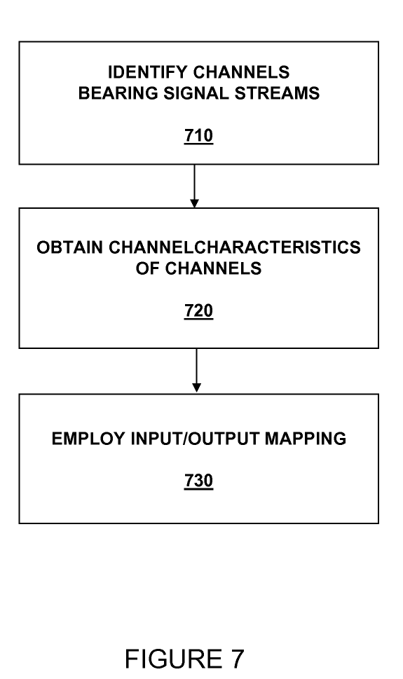

Turning now to FIG. 7, illustrated is a flow diagram demonstrating an exemplary method for selecting input/output mapping for a plurality of spatial resources of a relay node in a communication system according to the principles of the present invention. The method improves channel performance wherein a relay node with a plurality of antennas is inserted in communication channels bearing a plurality of signal streams (e.g., orthogonalized by encoding with a pseudo-random sequence) between source node(s) and destination node(s) of a communication system. In a step or module (hereinafter “module”) 710, a plurality of channels bearing signal streams is identified (e.g., in accordance with zero-forcing beamforming) from source node(s) to a destination node(s) via the relay node having the plurality of antennas. In a module 720, channel characteristics (e.g., channel state information, channel quality information and channel throughput) are obtained for the plurality of channels. The channel characteristics may be estimated from a pilot signal in the signal streams from the source to the destination node(s).

In a module 730, an input/output mapping for the plurality of spatial resources of the relay node is employed as a function of the channel characteristics for the signal streams over the plurality of channels from the source node(s) to the destination node(s). A selection of the input/output mapping may include selecting antenna weighting coefficients for the plurality of antennas of the relay node. The selection of the input/output mapping may also be a function of a quality of service for the signal streams over the plurality of channels from the source node(s) to the destination node(s). The relay node may receive the input/output mapping for the plurality of spatial resources from a destination node. Additionally, it should be understood that the plurality of channels may include a first type of channel between the source node(s) and the relay node and a second, different type of channel between the relay node and the destination node(s). The exemplary method as described herein is operable on a processor of the relay node of the communication system.

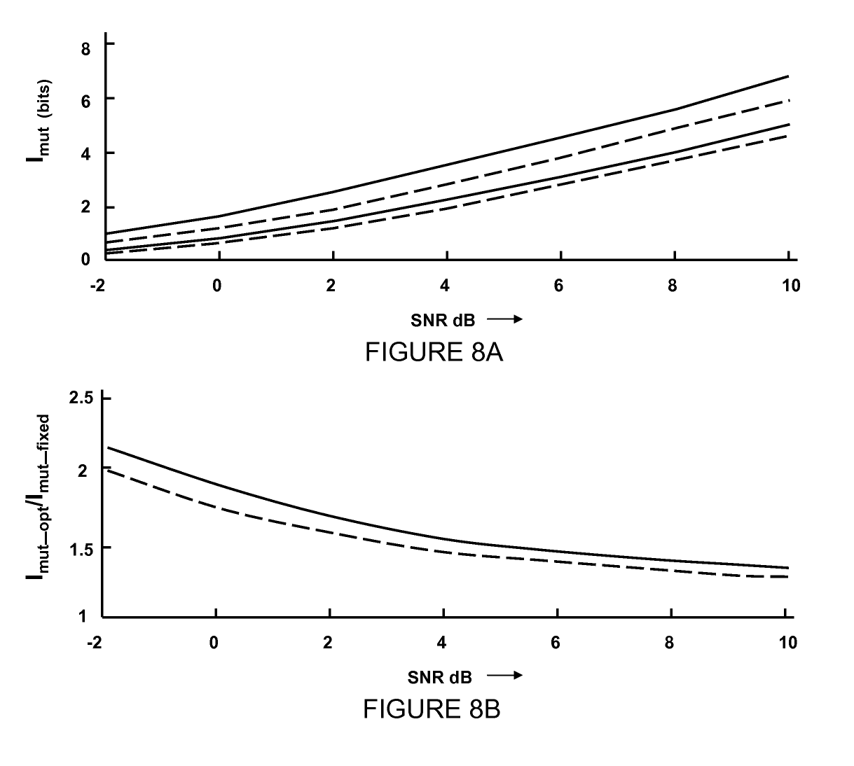

Turning now to FIG. 8A, illustrated is a graphical representation demonstrating relative mutual information (bits per channel use Iₘᵤₜ) at a destination node in accordance with an embodiment of a relay node of the present invention. The solid line represents the mutual information at the destination node in accordance with an exemplary input/output mapping at a relay node in accordance with the principles of the present invention and the dashed line represents a conventional antenna mapping employing fixed antenna switching in different SNR regimes in decibels (“dB”). The graph illustrates a 2×5×2 (solid lines) and a 2×4×2 (dashed lines) relay node arrangement (i.e., for two source-destination pairs with a single 4- or 5-antenna relay node). The source-to-relay node SNR and the relay-to-destination node SNR are assumed to be the same in an independent and identically distributed Rayleigh fading MIMO relay channel. The mutual information at destination node is computed for multi-user, zero-forcing beamforming, as described for no permutation matrix at the relay node by Rankov and by Berger, and for a permutation matrix at the relay node as introduced herein.

Turning now to FIG. 8B, illustrated is a graphical representation demonstrating a ratio (Iₘᵤₜ_{_{—}}ₒₚₜ/Iₘᵤₜ_{_{—}}_{fixed}) of mutual information at a destination node in accordance with an embodiment of a relay node of the present invention compared to a conventional relay node. The solid line represents the mutual information at the destination node in accordance with an exemplary input/output mapping at a relay node in accordance with the principles of the present invention and the dashed line represents a conventional antenna mapping employing fixed antenna switching in different SNR regimes in decibels (“dB”). The graph illustrates a 2×5×2 (solid line) and a 2×4×2 (dashed line) relay node arrangement (i.e., for two source-destination pairs with a single 4- or 5-antenna relay node). It can be observed in FIG. 8B that the input/output mapping at the relay node in accordance with the principles of the present invention provides a 2.5-3.5 dB performance gain over a conventional arrangement. The utilization of the input/output mapping at the relay node in accordance with the principles of the present invention more than doubles the information capacity in a low SNR regime, while the gain is more modest in a high SNR regime. The case with four relay antennas represents a practical case recognizing that four-antenna MIMO systems for local area networks operating under draft specification IEEE 802.11n, which is incorporated herein by reference, are already commercially available.

Thus, an apparatus, system and method has been introduced for the implementation of input/output mapping of spatial resources at a relay node having a plurality of antennas, including antenna weighting coefficients, to obtain improved channel performance in a communication system. The apparatus (e.g., a processor of the relay node) employs the input/output mapping for the spatial resources of the relay node as a function of channel characteristics or a quality of service for signal streams over a plurality of channels from source node(s) to destination node(s) via the relay node, or in accordance with indexing messages from another node (such as the source node(s) to destination node(s)).

Program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus, comprising:
a channel manager configured to identify a plurality of channels bearing signal streams from a source node to a destination node via a relay node; and
a channel allocator configured to employ input/output mapping for a plurality of spatial resources of said relay node as a function of channel characteristics of said plurality of channels for said signal streams.

2. The apparatus as recited in claim 1 wherein said channel manager is configured to obtain said channel characteristics of said plurality of channels and said channel allocator is configured to select said input/output mapping for said plurality of spatial resources of said relay node as a function thereof.

3. The apparatus as recited in claim 1 wherein said plurality of spatial resources of said relay node comprise a plurality of antennas and said channel allocator is configured to select antenna weighting coefficients for said plurality of antennas of said relay node.

4. The apparatus as recited in claim 1 wherein said channel allocator is configured to employ said input/output mapping for said plurality of spatial resources of said relay node as a function of a quality of service for said signal streams.

5. The apparatus as recited in claim 1 wherein said channel characteristics include at least one of channel state information, channel quality information, channel quality target, and channel throughput.

6. The apparatus as recited in claim 1 wherein said channel allocator is configured to receive said input/output mapping for said plurality of spatial resources from said destination node.

7. The apparatus as recited in claim 1 wherein said channel characteristics are configured to be estimated from a pilot signal in said signal streams.

8. The apparatus as recited in claim 1 wherein said channel manager configured to identify said plurality of channels bearing said signal streams from said source node to said destination node in accordance with zero-forcing beamforming.

9. The apparatus as recited in claim 1 wherein said plurality of channels include a first type of channel between said source node and said relay node and a second type of channel between said relay node and said destination node.

10. The apparatus as recited in claim 1 wherein said input/output mapping for said plurality of spatial resources is employed to reduce interference between said plurality of channels for said signal streams.

11. A computer program product comprising a program code stored in a computer readable medium configured to:
identify a plurality of channels bearing signal streams from a source node to a destination node via a relay node; and
employ input/output mapping for a plurality of spatial resources of said relay node as a function of channel characteristics of said plurality of channels for said signal streams.

12. The computer program product as recited in claim 11 wherein said program code stored in said computer readable medium is configured to obtain said channel characteristics of said plurality of channels and select said input/output mapping for said plurality of spatial resources of said relay node as a function thereof.

13. The computer program product as recited in claim 11 wherein said plurality of spatial resources of said relay node comprise a plurality of antennas and said program code stored in said computer readable medium is configured to select antenna weighting coefficients for said plurality of antennas of said relay node.

14. A method, comprising:
identifying a plurality of channels bearing signal streams from a source node to a destination node via a relay node; and
employing input/output mapping for a plurality of spatial resources of said relay node as a function of channel characteristics of said plurality of channels for said signal streams.

15. The method as recited in claim 14 further comprising obtaining said channel characteristics of said plurality of channels and selecting said input/output mapping for said plurality of spatial resources of said relay node as a function thereof.

16. The method as recited in claim 14 wherein said plurality of spatial resources of said relay node comprise a plurality of antennas and said method further comprises selecting antenna weighting coefficients for said plurality of antennas of said relay node.

17. The method as recited in claim 14 further comprising receiving said input/output mapping for said plurality of spatial resources from said destination node.

18. The method as recited in claim 14 further comprising estimating said channel characteristics from a pilot signal in said signal streams.

19. The method as recited in claim 14 wherein said identifying said plurality of channels bearing said signal streams from said source node to said destination node is performed in accordance with zero-forcing beamforming.

20. The method as recited in claim 14 wherein said input/output mapping for said plurality of spatial resources is employed to reduce interference between said plurality of channels for said signal streams.
